(19) United States
(12) Patent Application Publication
(10) Pub. No.: US 2019/0219539 A1
(43) Pub. Date: Jul. 18, 2019

(54) Continuous Monitoring of Selenium in Water

(71) Applicant: Southern Research Institute, Birmingham, AL (US)

(72) Inventors: Chaoyang HUANG, Marietta, GA (US); Kristen JENKINS, Brookhaven, GA (US); Corey Alan TYREE, Birmingham, AL (US)

(21) Appl. No.: 16/227,989

(22) Filed: Dec. 20, 2018

Related U.S. Application Data
(60) Provisional application No. 62/608,804, filed on Dec. 21, 2017.

(51) Int. Cl. G01N 27/48; B01D 53/50; B01D 53/78; B01D 53/80; G01N 1/44; F01K 13/00

(52) U.S. Cl. CPC G01N 27/48; B01D 53/501; B01D 53/78; B01D 2257/302; G01N 1/44; F01K 13/003; B01D 53/80

(57) ABSTRACT

A method of continuously sampling and detecting a presence of selenium within water includes extracting an aqueous sample from a source of water, conditioning the aqueous sample within a conditioning unit to form a conditioned sample, where the conditioning includes providing the aqueous sample to the conditioning unit, combining a conditioning solution with the aqueous sample, where the conditioning solution comprises a combination of an oxidizing agent comprising nitric acid and a reducing agent comprising hydrochloric acid, and heating the sample combined with conditioning solution at a sufficient temperature and for a sufficient time period to convert selenium and/or selenate within the sample to selenite. The method further includes detecting a concentration of selenite in the conditioned sample within a detection unit.

### FIELD OF THE INVENTION

The present invention relates to monitoring of contaminants in aqueous streams, e.g., selenium in waste water streams produced by industrial operations such as coal-fired power plants, petroleum refineries, mining, or other water streams containing selenium.

### BACKGROUND

Industrial operations commonly use water to convert raw materials into products. If the water contacts raw materials, products, or by-products that contain contaminants, the water can become contaminated and therefore must be managed as a waste water stream. For example, when coal is burned to generate electricity, water comes into contact with raw coal, coal by-products such as fly ash, and coal flue-gas. As a result, coal fired power plants generate waste water containing contaminants such as arsenic, selenium and mercury, requiring treatment prior to discharge to the environment. One example waste water stream is the water used by wet flue gas desulfurization (FGD) systems or wet scrubbers to remove sulfur oxides. These FGD systems utilize water-based liquids to absorb sulfur oxides and other contaminants such as metals and/or metalloids including selenium, arsenic, and mercury. As a result, FGD systems produce waste water containing these contaminants. Waste water from other industrial operations, such as mining and petroleum refining, can also generate waste water contaminated by these same species.

With an increasing awareness and concern for reducing environmental impact of waste water, newly issued waste water discharge permits for industrial sites can include stringent limits for contaminants. This requires industry to install waste water treatment systems to remove contaminants prior to discharge. To ensure these treatment systems meet discharge limits, industry will be required to monitor the presence of those contaminants on a routine basis.

It is difficult to continuously monitor certain trace metals and/or other contaminants in waste water and also in waste water treatment facilities. Depending upon the facility in which water is to be analyzed and treated, the water stream composition and treatment process can fluctuate from day-to-day. These process conditions and high variability require continuous monitoring systems to measure trace concentrations over a wide range of waste water chemistries and facility conditions.

Due to the difficulty of continuous monitoring for these constituents, facilities are expected to collect grab samples from waste water treatment influents, intermediate process steps, and effluents on an intermittent basis and ship those samples to an offsite laboratory for analysis. For example, selenium is typically measured by Inductively Coupled Plasma Mass Spectrometry (ICP-MS, EPA method 200.8) due to its high sensitivity and multi-elemental detection capability. Besides its high equipment cost, ICP-MS requires the expertise of an analytical chemist to operate, maintain, and interpret the data. In addition, ICP-MS is unsuitable for on-site, continuous trace contaminant monitoring because of its relatively large instrument size and use of a high temperature plasma (about 7000° C.) that requires a source of argon onsite. Reliable detection and analysis of contaminant species within a waste water sample is a labor-intensive, time-intensive, and expensive process that results in operators receiving data days or weeks after the sample was collected. The lack of real-time data also means operations staff will not be able to fully optimize the system, which will lead to increased operating costs and compliance risk.

There are other known analytical instruments and corresponding techniques which can measure selenium in the selenite or selenate state without the need for an ICP-MS instrument. Examples include voltammetry and Raman spectroscopy. For example, certain offsite laboratory instruments have sample conditioning procedures to convert selenate to selenite or selenite to selenate depending on the instrument used. However, these known techniques do not account for the transformation of elemental or other forms of selenium to selenite or selenate. In addition, such known conversion techniques do not adequately condition the sample in the complex water matrices typical of industrial waste water streams (e.g. water samples that contain high levels of organics or dissolved solids). As a result, a more robust sample conditioning system is needed to condition samples for continuous measurement across a wide range of water compositions.

It would be desirable to provide a more robust continuous monitoring system for adequately conditioning samples and monitoring contaminants such as selenium across a wide range of water compositions, particularly for use in monitoring contaminants in a waste water stream so as to provide real-time data for cost-efficient waste water management that also minimizes compliance risks for plants.

### SUMMARY OF THE INVENTION

In example embodiments, a method of continuously sampling and detecting a presence of selenium within water comprises extracting an aqueous sample from a source of water, and conditioning the aqueous sample within a conditioning unit to form a conditioned sample, where the conditioning comprises providing the aqueous sample to the conditioning unit, combining a conditioning solution with the aqueous sample, where the conditioning solution comprises a combination of an oxidizing agent comprising nitric acid and a reducing agent comprising hydrochloric acid, and heating the sample combined with conditioning solution at a sufficient temperature and for a sufficient time period to convert selenium and/or selenate within the sample to selenite. The method further comprises detecting a concentration of selenite in the conditioned sample within a detection unit, where the detecting comprises providing the conditioned sample to the detection unit, and performing cathodic stripping voltammetry with the conditioned sample to determine a concentration of selenite within the conditioned sample.

In other example embodiments, a system for continuously sampling and detecting a presence of selenium within water is provided including a conditioning unit and a detection unit configured to perform the operations of the methods described herein.

In still further example embodiments, this method applies to industrial waste water like the waters produced from mining, petroleum refining, and power plant operations. More specific examples include flue gas desulfurization (FGD) waste water, a stream commonly found at coal-fired power plants and petroleum refineries and other process industries. A fossil fuel power plant system comprises a fossil fuel power plant that burns a fossil fuel to generate electrical energy and outputs a flue gas, a scrubbing system that removes one or more sulfur oxides from the flue gas output by the fossil fuel power plant and outputs a sulfur purified gas and a waste water stream, a waste water treatment system that receives the waste water stream from the scrubbing system and removes one or more contaminants from the waste water stream, the one or more contaminants comprising one or more metals, and the continuous sampling and detection system for detection of selenium within aqueous samples withdrawn from the waste water stream prior to, within or after treatment. An aqueous sample can be a portion of the waste water stream obtained at any one or more locations prior to, within, or at the effluent of the waste water treatment system.

The above and still further features and advantages of embodiments of the present invention will become apparent upon consideration of the following detailed description thereof, particularly when taken in conjunction with the accompanying drawings wherein like reference numerals in the various figures are utilized to designate like components.

### BRIEF DESCRIPTION OF THE DRAWINGS

FIG. 1 is a schematic view of an example embodiment of a continuous sampling and detection system in accordance with the present invention.

FIG. 2 is a flowchart providing processing steps for conducting a detection and quantitative analysis of selenium in a water sample utilizing the system of FIG. 1.

FIG. 3 is a schematic view of an example embodiment of a water treatment plant that receives waste water used to process flue gas from a fossil fuel power plant, where the continuous sampling and detection system of FIG. 1 is integrated with the plant for analyzing selenium in water samples taken from the waste water.

FIG. 4 is a Pourbaix diagram of selenium (showing the thermodynamically stable phases of selenium species at different electrode potentials and based upon solution pH).

Like reference numerals have been used to identify like elements throughout this disclosure.

### DETAILED DESCRIPTION

In accordance with the present invention, a continuous water monitoring system provides accurate, real-time data regarding amounts of trace contaminants within a water sample. In particular, the continuous water monitoring system provides rapid and accurate, on-site determination of amounts of selenium within water samples. The system can be implemented for use in monitoring required for any water stream or body of water.

In example embodiments, the continuous water monitoring system can be integrated for use within a waste water treatment plant, such as a plant that receives waste water from a fossil fuel power plant (e.g., a coal-fired power plant). In particular, the waste water treatment plant can receive waste water that has been processed to remove one or more sulfur oxides (SOₓ), such as sulfur dioxide, from the exhaust flue gas stream of a coal-fired power plant. The continuous water monitoring system provides real-time data analysis of concentration of selenium species within, after, or prior to the waste water treatment system at one or more different locations of the waste water treatment system.

The system facilitates conversion of all or substantially all forms or species of selenium to selenite (Se IV, SeO₃²⁻) and/or selenate (Se VI, SeO₄²⁻) in order to facilitate continuous and accurate online monitoring of selenium using analytical detection instruments suitable for field deployment. In certain embodiments (e.g., monitoring waste water obtained from a flue gas desulfurization process, or FGD water), it is desirable to convert most or all selenium species within a water sample to selenite prior to detection. The process described herein is capable of such conversion to ensure accurate detection and measurement of selenium in the water sample. By accurately monitoring total selenium amounts in aqueous samples of a water stream in turn allows one to optimize processes for removing pollutants from the water stream and maintain compliance with regulatory limits.

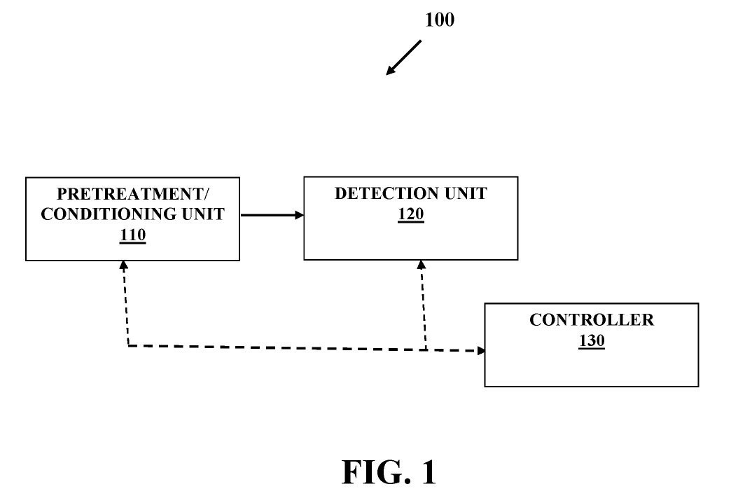

Referring to FIG. 1, an example embodiment of a system is schematically depicted for continuous monitoring of a waste water stream. In particular, a selenium detection system 100 includes a pretreatment or conditioning unit 110 to condition the sample prior to detection. The system further includes a detection unit 120 to analyze and detect selenium concentration in its reduced form (as selenite or selenate, preferably selenite as noted herein) in the conditioned aqueous sample received from the conditioning unit. The detection unit 120 can utilize electroanalytic methods such as voltammetry and/or spectrometric methods such as Raman spectroscopy for determining the concentration of selenium in the conditioned aqueous sample. In addition, the system 100 includes a controller 130 to receive measured data from the detection unit 120 in relation to selenium detection as well as provide control signals to the detection unit 120 and/or the conditioning unit 110 for facilitating automated control of system operations. The controller 130 includes one or more suitable processors as well as any suitable memory storage (e.g., system ROM and/or system RAM) to facilitate processing control during system operation as well as storage of any types of data associated with system operations (e.g., storage of operating parameters required for the conditioning and detection units, storage of measured data during detection of selenium, etc.).

The conditioning unit 110 can comprise any suitable vessel or container configured to receive a desired volume of a water sample for detection from a waste water stream. The conditioning unit 110 includes one or more inlets to receive a fluid sample via an inlet line or conduit extending from a waste water stream source to the inlet of the conditioning unit. Any suitable combination of pumps, valves, etc. can be provided along the inlet line which are optionally controlled by the controller 130 to facilitate automated and selective withdrawal of a suitable volume of a waste water sample from the waste water stream for delivery to the conditioning unit 110.

The pretreatment or conditioning unit 110 of the system 100 receives a water sample and conditions the sample based upon the composition of the sample and whether selenium is converted to selenite and/or selenate for analysis by the detection unit 120. As further described herein, it is preferred in some selenium detection systems (particularly when voltammetry is utilized) to convert selenium species to selenite prior to detection. In the conditioning unit 110, a further inlet line is provided for adding a conditioning solution including one or more suitable oxidizing and/or reducing agents (e.g., stored within one or more storage units in fluid communication with the conditioning unit 110) into the conditioning unit for mixing and combining with and conditioning the waste water sample. Any suitable mixer can be provided within the conditioning unit to facilitate suitable mixing of the contents therein. The controller 130 can be configured to selectively and automatically control delivery of such agents in suitable amounts into the conditioning unit 110 during system operations. Some examples of suitable conditioning agents are nitric acid and hydrochloric acid. The oxidizing and/or reducing agents facilitate conversion of elemental selenium into selenite and/or selenate so as to facilitate detection of selenium within the detection unit 120. Depending upon the water sample and the source, the amount of selenium can vary significantly. For example, in certain embodiments, the amount of selenium in an untreated water sample can vary from about 10 ppb (parts per billion) or μg/L to about 1000 ppb (μg/L) or greater. A treated water sample may have selenium concentrations less than the current method detection limit of approximately 1 ppb. A suitable amount of one or more oxidizing and/or reducing agents are added to the sample to suitably adjust the volumetric ratio of the sample to such agents.

The use of one or a combination of oxidizing and/or reducing agents will depend upon conditions of a water sample to be analyzed. For example, different industrial processes can generate waste water including different varieties or forms of selenium species, such that different combinations of oxidizing and/or reducing agents might be more beneficial for different forms of waste water in conversion to a desired selenium species for detection.

Selenium occurs in four redox states (VI, IV, 0 or −II) and can further exist in many chemical forms ranging from inorganic species (selenate, selenite, selenide, etc.), elemental selenium, organoselenium compounds (methylated selenium, etc.), to biological selenium species and reaction intermediates (selenocysteine, etc.). Accordingly, the term “selenium species” as used herein refers to elemental selenium as well as selenium in any of its other oxidation states. Typical selenium species found in water include its inorganic forms, i.e. selenite, selenate, elemental selenium, and selenide. Selenium speciation in wastewater streams differs among different industrial sectors as well as among different facilities in the same industrial sector. Within a facility, selenium speciation can vary depending on feed water sources/volumes, plant operation, and water treatment technology. For example, raw FGD (fuel gas desulfurization) wastewater can contain total selenium concentrations from below 100 μg/L (ppb) levels to thousands μg/L (ppb), with a distribution of selenate (typically the most predominant species), selenite, selenocyanate, selenosulfate, and/or other unknown species. For certain FGD operations, and depending upon variations in the process, the distribution of these selenium species in the waste water stream generated by the FGD process can vary on a daily basis.

Further, the characterization and distribution of selenium species in water and wastewater (e.g. FGD wastewater) becomes more complicated when a water treatment technology is utilized for selenium removal, especially when the technology is biologically based. In the biological process, a bacteria (under anaerobic conditions) converts both selenate and selenite to elemental selenium, prior to further disposal. This biological process can also generate some other selenium species (organic based) during the treatment period, and these species can be difficult to characterize and quantify.

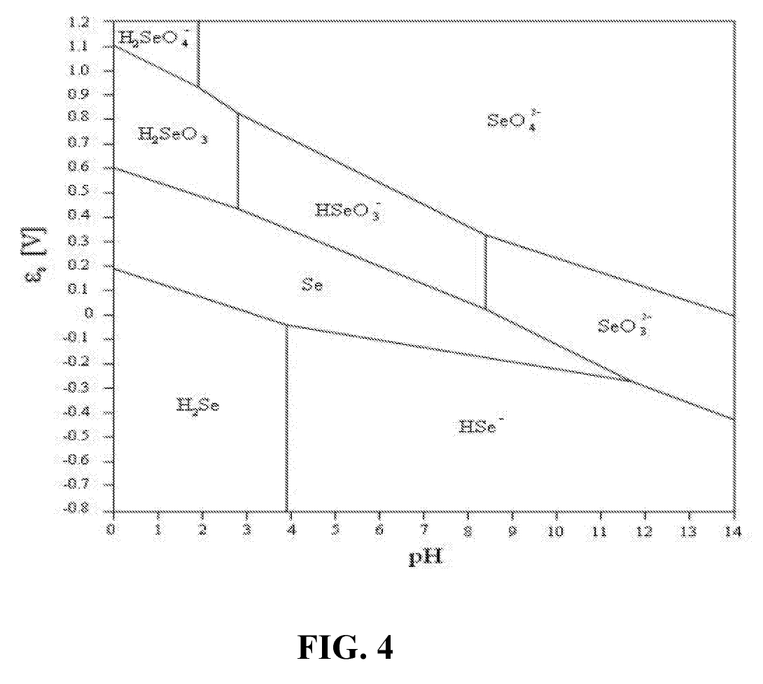

The number of different thermodynamically stable selenium species in an aqueous solution is based upon a pH value and a redox potential of the solution. The redox potential of selenium vs. pH is depicted in a Pourbaix diagram set forth in FIG. 4, where it can be seen that a lower solution pH and a lower redox potential favors reduced selenium species. Ideally, when utilizing a voltammetric method (e.g., cyclic voltammetric stripping) for selenium detection in a water sample, it is desired to condition a water sample so that substantially all selenium species in solution are converted to selenite (SeO₃²⁻) prior to detection. Since selenate is the predominant species in many water and waste water solutions (including FGD water), this species must be converted to selenite prior to detection. However, as can be seen from the Piourbaix plot of FIG. 4, selenite is stable in solution only in a narrow range of pH and redox potential. Due to the complexity of selenium species and the distribution of such species in water and wastewater, conversion of all species to selenite can be challenging since the process requires a reducing agent and an oxidizing agent to be present in solution so as to (a) reduce selenate (SeO₄²⁻) to selenite, and (b) oxidize elemental selenium, selenocyanate and other selenium forms to selenite. Conventional methods typically perform reduction and oxidation steps sequentially (i.e., not at the same time) so as to avoid interactions or reactions between different reagents if the reagents were provided together to achieve both reactions simultaneously. In addition, the selection of oxidation and reduction reagents requires careful consideration to avoid over-reaction of selenium species to other, undesirable oxidation states.

Since selenate is the dominant species in many industrial waste water streams (including FGD water), typically the objective is to reduce selenate to selenite to enable accurate detection of selenium content within a water sample. A conventional practice for reducing selenate to selenite has been subjecting a water solution to UV irradiation at an elevated temperature (e.g., about 90° C.), with some pH adjustment, and/or further providing hydrogen peroxide within the water solution to facilitate converting selenium to selenite. However, it has been determined that this practice is not ideal in that some selenite can be converted to selenate when exposed to UV irradiation.

However, it has been determined that the use of a combination of an oxidizing agent comprising nitric acid (HNO₃) with a reducing agent comprising hydrochloric acid (HCl) during conditioning at an elevated temperature (e.g., about 95° C.), results in the formation of stable selenite at the pH and redox potential ranges as set forth in the Piourbaix plot of FIG. 4. For example, a conditioning solution can be provided that includes a combination of oxidizing and conditioning agents comprising about 30% v/v to about 100% v/v (about 5 molar (M) to about 15 molar (M)) nitric acid and about 30% v/v to about 100% v/v (about 4M to about 12M) hydrochloric acid, where such conditioning solution facilitates conversion of selenium species to predominantly selenite in solution.

Utilizing nitric acid in the concentrations described herein, elemental selenium as well as other low oxidation state selenium species can be oxidized to selenite without further oxidation to selenate, where the oxidation reaction from Se (0) to Se (IV) is as follows:

4HNO₃+Se(s)⇄4NO₂(g)+H₂SeO₃(aq)+H₂O (Equation 1)

Other low oxidation species (e.g., organic selenium) can also be converted to selenite with the further oxidation of organic components to carbon dioxide.

The reduction of selenate (Se VI) to selenite using hydrochloric acid in the concentrations as described herein yields a reaction as follows:

SeO₄²⁻+4H⁺⁺2Cl⁻⇄H₂SeO₃+Cl₂+H₂O₂ (Equation 2)

Thus, a conditioning solution including the combination of HNO₃ with HCl in the concentrations described herein has been found to convert all other selenium species to selenite while minimizing or preventing the occurrence of over-oxidation (e.g., to selenate) or over-reduction. This combination further facilitates simultaneous oxidation and reduction reactions (e.g., the reactions of Equations 1 and 2) in a single step (e.g., in a single conditioning vessel or conditioning unit) rather than requiring separate and sequential conditioning steps.

Referring again to FIG. 1, the conditioning unit 110 further includes suitable heating equipment (e.g., in the form of any suitable type or types of direct heaters and/or heat exchangers) to heat the sample at a suitable temperature for a sufficient heating period to facilitate suitable oxidation and/or reduction of selenium and/or other components within the sample while also decomposing any organic compounds or other organic matter (e.g., micro-organisms) that may be present in the sample. The heating equipment can also be selectively and automatically controlled by the controller 130 during system operations. In an example embodiment, the sample is heated to a temperature in a range from about 90° C. to about 105° C. (e.g., from about 95° C. to about 100° C.) with or without acid addition for a period of 60 minutes or less (e.g., from about 30 minutes to about 40 minutes). Such heating (in combination with the oxidizing and reducing agents in solution) converts selenate to selenite within the conditioned sample while also decomposing organic compounds or other organic matter within the sample. This process can also convert elemental selenium and other selenium species to selenite.

Optionally, the conditioning unit 110 can also be provided with an ultraviolet (UV) light source (also selectively and automatically controlled by the controller 130) for subjecting the sample to UV radiation (e.g., transmission of light by the UV light source toward the sample at a wavelength ranging from about 10 nm to about 400 nm). Subjecting the sample to UV irradiation can further condition the sample so as to convert certain selenium species to selenite or selenate for detection by the detection unit. For certain aqueous samples, UV irradiation further digests or breaks down organic material within the sample. The sample can be subjected to UV irradiation by the UV light source for a suitable time period (e.g., 60 minutes or less, such as from about 20 minutes to about 40 minutes, or about 30 minutes). However, as previously noted, for certain types of waste water samples (including FGD water samples), it has been determined that the use of UV irradiation may actually be detrimental to conversion to selenite. Therefore, e.g., when processing FGD water samples, it has been determined that UV irradiation is avoided (i.e., not used) during the conditioning of the water sample prior to the voltammetry detection (i.e., the conditioning of the water sample is free from any UV irradiation). However, when utilizing other forms of detection instead of voltammetry (e.g., Raman spectroscopy), it may be desirable to subject the sample to UV irradiation prior to performing selenium detection.

The detection unit 120 includes suitable equipment for receiving the conditioned sample from the conditioning unit and performing voltammetry and/or spectroscopy (e.g., Raman spectroscopy) on the sample to determine a selenium concentration in the sample. In example embodiments, the detection unit 120 includes suitable equipment for performing a voltammetric stripping technique to determine a selenium concentration within the sample. In particular, the detection unit 120 includes a voltammetry unit configured to perform cathodic stripping voltammetry for the sample residing within the unit so as to determine selenium concentration. The voltammetry unit can be a conventional unit capable of performing cathodic stripping voltammetry and including a container or vessel for receiving (via an inlet) and retaining the sample solution, a working electrode, a counter electrode and a reference electrode, where the working electrode comprises a hanging mercury drop electrode (HDME), and an outlet to facilitate removal of the sample from the container after detection of the sample has been performed. The voltammetry unit further includes a potentiostat for establishing a desired voltage between electrodes (e.g., working and reference electrodes) within the detection unit. The controller 130 selectively and automatically controls operation of the detection unit 120 and is further configured to receive data signals from the detection unit in relation to voltammetric stripping operations performed by the detection unit, where the data signals can be further processed and/or saved by the controller 130. The data signals can represent current and/or voltage data from the voltammetric process which is used to determine selenium concentration in the sample. In embodiments in which a spectrometer is utilized (e.g., to conduct Raman spectroscopy on the sample), data signals can be provided by the spectrometer to the controller 130 which can be utilized to determine selenium concentration in the sample.

The conditioned sample can be further diluted within the detection unit 120 prior to performing the voltammetry process. For example, a reservoir can be connected with the detection unit 120 for providing an electrolyte to the detection unit container holding the sample, where the injection of electrolyte into the detection unit container can be selectively and automatically controlled by the controller 130. The electrolyte can be combined in a suitable amount with the conditioned sample along with de-ionized (DI) water (a diluent) to achieve a desired volume of each of the conditioned sample and electrolyte within the sample. A typical electrolyte that can be added to a sample for voltammetry is ammonium sulfate. However, if a water sample contains high amounts of calcium and/or magnesium (common cations present in aqueous samples), this can cause salt scaling on the HDME which in turn causes a loss in sensitivity to detection and analysis of selenium species within the sample. In such scenarios, frequent maintenance and cleaning of the HDME is required to ensure adequate performance of the detection unit. In example embodiments herein, an alternative electrolyte salt comprising ammonium chloride can be provided in the conditioned sample to inhibit or avoid a build-up of solids on the HDME during voltammetry. Further still, the oxidizing and/or reducing agents in solution, provided at the concentrations noted herein during the conditioning step, can also provide electrolytic activity within the solution (e.g., H⁺, NO₃⁻, and Cl⁻ ions in solution from dissociated nitric acid and hydrochloric acid can serve as electrolytes).

In addition, rhodium (Rh) can also be combined with the electrolyte so as to be provided within the conditioned sample to enhance the sensitivity of the detection unit to measure selenium concentration within the sample. The addition of Rh in the sample (instead of copper, which is typically used for selenium measurement using cathodic stripping voltammetry) results in formation of rhodium selenide at the surface of the HDME. During the stripping portion of the voltammetry process, when rhodium selenide is reduced, the electrochemical response is much larger (i.e., larger peak) in comparison to responses generated during stripping of, e.g., copper selenide from the HDME surface. Thus, the use of Rh results in accurate detection and measurement of small traces of selenide (and thus selenium) within the sample. In example embodiments, a suitable amount of Rh is added to the conditioned sample for processing within the detection unit such that the concentration range of Rh within solution is from about 2 ppm (μg/mL) to about 5 ppm (m/mL).

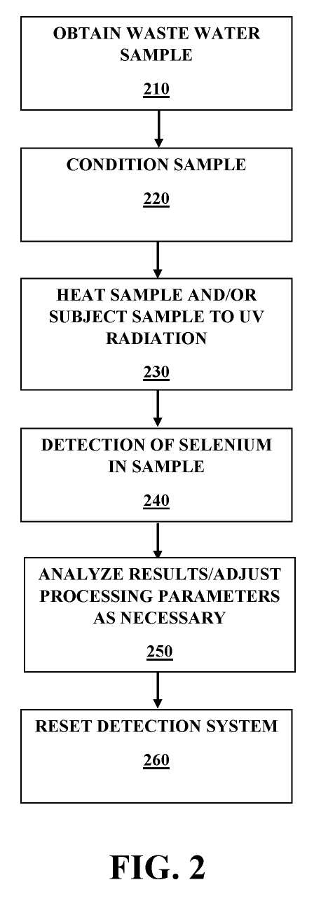

An example embodiment of a method for detecting and measuring a concentration of selenium in a water sample utilizing the continuous water monitoring system is now described with reference to the flowchart in FIG. 2. As previously noted, the system controller 130 can be configured to selectively and automatically control components of the system 100 such that performance of the operational steps described in FIG. 2 are all controlled by the controller 130.

At 210, a waste water sample (e.g., about 1 mL to about 10 mL, such as about 2 mL to about 5 mL) is extracted from a waste water supply (e.g., from a flowing waste water stream, or from a reservoir containing a volume of waste water). The sample is provided to the pretreatment/conditioning unit 110, and at 220 the sample is conditioned in the unit 110 (e.g., by adding one or more oxidizing and/or reducing agents in selected amounts). At 230, the sample can further be heated to a suitable temperature and/or subjected to UV radiation for a specified time period as described herein. At 240, the sample is directed to the detection unit 120 where a detection process (e.g., cyclic voltammetry and/or Raman spectroscopy) is performed to determine the presence of selenium as well as its concentration in the sample. At 250, the controller 130 receives data signals from the detection unit 120 and analyzes the data to determine whether selenium is present within the sample and, if so, what is the concentration of selenium within the sample. This data can be used in system operations relating to the waste water (e.g., to adjust operating parameters associated with a waste water treatment facility if it is determined selenium concentration in the waste water is not within a desired range or is not below a suitable value). After the detection process, the controller 130 can (at 260) reset the detection system 100 by facilitating removal of the sample from the detection unit 130 and providing any suitable calibration steps necessary to facilitate analysis of a subsequent sample (e.g., washing/rinsing the conditioning and detection units, re-calibrating detection equipment, etc.).

The continuous monitoring and detection system of the present invention facilitates detection of the presence and an amount of selenium at very small concentrations (e.g., in the ppb range, such as concentrations of 5 ppb or less, or even concentrations of 1 ppb or less).

### EXAMPLE 1

### Calibration of Voltammetric Unit

Prior to analyzing waste water samples for detection of selenium, system calibration of the detector unit 120 can be performed, where such calibration can also be automatically controlled by the system controller 130. Calibration can occur on a periodic basis (e.g., daily). For calibration of a volammetric unit, a predefined volume (3 mL) of a working standard selenium solution is automatically delivered to the voltammetry container for voltammetric analysis. The selenium working standard solution contains 0.1mg/L Se, which is made from a simple two-step serial dilution of a NIST traceable 1000 mg/L Se primary standard (e.g., commercially available from Sigma-Aldrich).

The working standard selenium solution is combined in the conditioning unit with 6 mL concentrated nitric acid (15M HNO₃) and 3 mL concentrated hydrochloric acid (12M HCl). The combined solution is sufficiently mixed and heated to about 95-100° C. for about 30-40 minutes, and then cooled to ambient temperature (about 20-25° C.).

A 2 mL amount of the conditioned working standard selenium solution is next provided to a container of the voltammetry unit which includes the HDME, counter and reference electrodes. The conditioned solution is diluted with 10 mL of DI water and a sufficient amount of electrolyte solution including Rh such that a sufficient amount of Rh (about 2 ppm to about 5 ppm) is in the sample (e.g., adding 50 μL of a solution that contains 1000 μg/mL of Rh). The electrolytes in solution can also come solely from the concentrated HCl and HNO₃ already in solution (which were provided during the conditioning step).

The calibration process obtains data from cyclic voltammetry performed on the working standard selenium solution, and this calibration data is used to determine concentrations of selenium in waste water samples.

The voltammetric unit is set to perform a cathodic stripping voltammetric technique utilizing the parameters as set forth in Table 1:

TABLE 1
Parameters for Voltammetric Unit

| Working electrode | HMDE | |
|---|---|---|
| Stirrer speed | 2000 | rpm |
| Mode | DP (differential pulse) | |
| Purge time | 300 | seconds |
| Deposition potential | −0.4 | V |
| Deposition time | 90 | seconds |
| Equilibration time | 10 | seconds |
| Start potential | −0.45 | V |
| End potential | −1.2 | V |
| Peak potential Se(IV) | −0.65 | V |

A limit of detection for the detection unit was also tested by preparing standard selenate (Se(VI)) and selenite (Se(IV)) solutions at 10 μg/L (10 ppb). Each solution was prepared in seven trial replicates. The prepared solutions were subjected to conditioning and analysis in the same manner as the previously described calibration methods. The results of the analysis are provided in Table 2 as follows:

TABLE 2
Results of Limit of Detection Analysis

| | 10 ppb from | 10 ppb from |
|---|---|---|
| | processed Se(IV) | processed Se(VI) |
| Replicates | measured, μg/L | measured, μg/L |
| 1 | 10.0 | 9.8 |
| 2 | 10.5 | 9.0 |
| 3 | 10.3 | 9.8 |
| 4 | 10.7 | 10.9 |
| 5 | 10.6 | 9.4 |
| 6 | 11.0 | 9.4 |
| 7 | 11.1 | 9.2 |
| AVG | 10.6 | 9.6 |
| STDEV | 0.38 | 0.64 |
| LOD (=3.3 *STDEV) | 1.26 | 2.13 |

The LOD results indicate that detection is accurate for selenium concentrations (measured as selenite or selenate) at least as low as 10 ppb in waste water samples.

### EXAMPLE 2

Using the system 100 of FIG. 1, a 100 mL water sample including selenium is collected from a waste water stream. The water sample is sufficiently mixed to ensure homogeneity of the sample, and a 3 mL aliquot of the water sample is then combined in the conditioning unit with 6 mL concentrated nitric acid and 3 mL concentrated hydrochloric acid. The combined solution is sufficiently mixed and heated to about 95-100° C. for about 30-40 minutes, and then cooled to ambient temperature (about 20-25° C.).

A 2 mL amount of the conditioned sample is next provided to a container of the voltammetry unit which includes the HDME, counter and reference electrodes. The conditioned sample is diluted with 10 mL of DI water and a sufficient amount of electrolyte solution including Rh such that a sufficient amount of Rh (about 2 ppm to about 5 ppm) is in the sample (e.g., adding 50 μL of a solution that contains 1000 μg/mL of Rh).

The voltammetric unit is set to perform a cathodic stripping voltammetric technique utilizing the parameters as set forth in Table 1. The detection process can determine a concentration of selenium in the sample in amounts as low as 10 ppb or even lower.

### EXAMPLE 3

A 3.0 mL waste water sample is collected and provided in the conditioning unit, to which is added 6.0 mL concentrated nitric acid and 3.0 mL concentrated hydrochloric acid. The contents are suitably mixed and heated to a temperature of about 95° C. to about 100° C. for about 45 minutes. The sample is then allowed to cool to ambient temperature.

About 2 mL of the conditioned sample is transferred to the container of the detection unit which includes the HDME, reference and working electrodes, and about 8.0 mL of deionized (DI) water is combined with the sample in the detector unit container. Next, about 0.025 mL of a standard rhodium solution (concentration of rhodium is 1 mg/mL) is added to the container. For all samples tested, the voltammetric unit is set to perform a cathodic stripping voltammetric technique utilizing the same parameters as set forth in Table 1.

The voltammetric unit is set to perform a cathodic stripping voltammetric technique utilizing the parameters as set forth in Table 1. The detection process can determine a concentration of selenium in the sample in amounts as low as 10 ppb or even lower.

Utilizing a process such as described in the example herein, the continuous water quality monitoring system can be utilized to continuously monitor and quantify an amount of selenium within any water stream (or any body of water) in which such monitoring is desired.

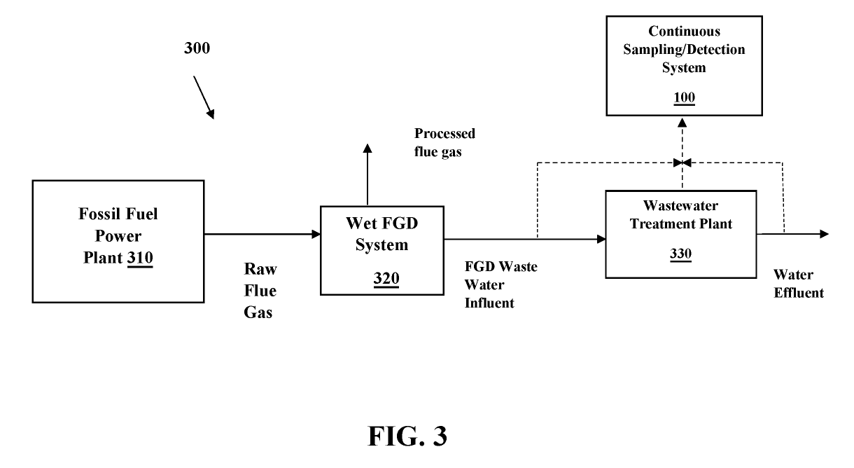

An example embodiment is depicted in FIG. 3 of a system that implements a continuous water monitoring system in accordance with the present invention. The system 300 includes a fossil fuel power plant 310, such as a coal-fired power plant, that utilizes the fossil fuel to generate energy (e.g., electrical energy via generation of steam by combustion of coal or fossil fuel, where the steam can be used to power turbines to generate electrical energy). In accordance with many government regulations having authority in the geographic location in which the power plant operates, the flue gas emissions formed from the burning of the fossil fuel must be purified to remove contaminants such as sulfur dioxide from the flue gas prior to being released to the environment. A wet flue gas desulfurization (FGD) system 320 is commonly used to remove sulfur oxides and other contaminants from flue gas from power plants 310. The processed flue gas emerging from the wet FGD system 320 can be further processed or (if satisfying government regulations for content) can be released to the environment.

The wet FGD system 320 utilizes one or more wet scrubbing processes to remove sulfur oxides from the flue gas influent. The wet scrubbing typically requires the flue gas to be subjected to treatment with an alkali solution, e.g., an aqueous slurry comprising calcium carbonate (limestone), calcium hydroxide (hydrated lime), or magnesium hydroxide. Wet scrubbing can also be performed utilizing, e.g., an aqueous solution comprising sodium hydroxide). The scrubbing process purifies the flue gas removing significant amounts of sulfur from the gas, while also producing waste water that must be treated (in accordance with an individual plants discharge permit) prior to being released to the environment. The waste water from the wet FGD system 320, also referred to as FGD water, is provided as influent to a waste water treatment plant 330. The waste water treatment plant 330 processes the FGD water to remove certain trace contaminants (e.g., metals and/or metalloids such as mercury, arsenic, selenium as well as certain organic contaminants) from the waste water.

An important part of the process for the waste water treatment plant 330 is the monitoring of the concentration(s) of one or more contaminants (e.g., one or more metals and/or metalloids including selenium, organic compounds, etc.) in the waste water so as to determine the effectiveness of the waste water treatment process and whether the conditions of the process need to be modified in any manner. The continuous water sampling and detection system 100 is integrated within the plant 330 to monitor waste water samples at one or more locations of the plant 330. This provides continuous sampling, detection and quantifying the presence of selenium in real-time, which can in turn provide feedback to the plant operators of the waste water treatment plant 300 for controlling operating parameters of the plant.

The continuous water sampling and detection system 100 provides a significant advantage over conventional techniques for monitoring selenium in water streams. Conventional detection techniques require samples to be collected and delivered to an offsite location for determination of constituent concentrations, where plant/facility operators must typically wait for several days for feedback on selenium concentrations within the waste water. The system of the present invention allows for immediate and real-time or near real-time feedback to plant operators, which in turn facilitates a more efficient processing of the water within the waste water treatment plant.

The present invention further facilitates conversion of all selenium species to either selenite or selenate (i.e., the process described herein in accordance with the invention preferably facilitates conversion of selenate, elemental selenium, and other selenium species to selenite; however, alternatively the process can also be configured to convert selenite, elemental selenium, and other forms of selenium to selenate) to facilitate continuous, online monitoring of selenium using analytical detection instruments suitable for field deployment. Such conversion is achieved through oxidization and/or reduction with heating of the sample and reagents for a specific period of time as described herein, thus allowing for an accurate determination of selenium concentration in the sample. In addition, the techniques as described herein can be further modified to allow for a determination of individual species of selenium.

The present invention provides accurate monitoring of the total selenium concentration in aqueous samples, which allows users to monitor the amount of pollutant in a given stream, optimize processes designed to remove pollutants, and track compliance with regulatory limits.

While the invention has been described in detail and with reference to specific embodiments thereof, it will be apparent to one skilled in the art that various changes and modifications can be made therein without departing from the spirit and scope thereof

For example, the present invention is not limited to sampling and detection of waste water used to scrub flue gas from a fossil fuel burning power plant. Instead, the continuous sampling and detection system of the present invention can be implemented in any water treatment facility in which at least selenium must be removed from the water prior to the water being released to the environment. Alternatively, the present invention can be implemented for use in any scenario in which a body of water is to be analyzed for the presence (and amount) of selenium in such body of water. Further, while the embodiments described herein are described in relation to detection of concentrations of selenium, the continuous sampling and detection system of the present invention can also be configured for detection of any other metals and/or contaminants within water.

Thus, it is intended that the present invention covers the modifications and variations of this invention provided they come within the scope of the appended claims and their equivalents.

What is claimed:

1. A method of continuously sampling and detecting a presence of selenium within water, the method comprising:
extracting an aqueous sample from a source of water;
conditioning the aqueous sample within a conditioning unit to form a conditioned sample, the conditioning comprising:
providing the aqueous sample to the conditioning unit;
combining a conditioning solution with the aqueous sample, wherein the conditioning solution comprises a combination of an oxidizing agent comprising nitric acid and a reducing agent comprising hydrochloric acid; and
heating the sample combined with conditioning solution at a sufficient temperature and for a sufficient time period to convert selenium and/or selenate within the sample to selenite; and
detecting a concentration of selenite in the conditioned sample within a detection unit, the detecting comprising:
providing the conditioned sample to the detection unit; and
performing cathodic stripping voltammetry with the conditioned sample to determine a concentration of selenite within the conditioned sample.

2. The method of claim 1, wherein hydrochloric acid is provided in the conditioning solution at a concentration from about 4M to about 12M.

3. The method of claim 1, wherein nitric acid is provided in the conditioning solution at a concentration from about 5M to about 15M.

4. The method of claim 1, further comprising:
adding rhodium within the conditioned sample and prior to the detecting.

5. The method of claim 4, wherein rhodium is added to the conditioned sample so as to be present in the conditioned sample in an amount from about 2 ppm to about 5 ppm.

6. The method of claim 1, further comprising:
adding ammonium chloride within the conditioned sample and prior to the detecting.

7. The method of claim 1, wherein the sample is heated to a temperature in a range from about 90° C. to about 105° C. for a period of about 60 minutes or less.

8. The method of clam 1, further comprising:
processing a flue gas from a fossil fuel power plant in a wet flue gas desulfurization (FGD) system utilizing an aqueous scrubbing solution to remove one or more sulfur oxides from the flue gas to form a stream of FGD water; and
directing the stream of FGD water to a water treatment plant for processing by the water treatment plant to remove contaminants from the FGD water to produce a treated waste water, the contaminants comprising one or more species of selenium;
wherein the extracting an aqueous sample from a source of water comprises extracting a sample from the treated waste water.

9. A continuous sampling and detection system for contaminants within water, the system comprising:
a conditioning unit configured to receive an aqueous sample from a source of water and form a conditioned sample, the conditioning unit comprising:
a container to receive and condition the aqueous sample via addition of one or more oxidizing agents and/or reducing agents to the aqueous sample;
a reservoir to provide and combine a conditioning solution with the aqueous sample in the container, wherein the conditioning solution comprises a combination of an oxidizing agent comprising nitric acid and a reducing agent comprising hydrochloric acid; and
a heating unit to heat the aqueous sample combined with conditioning solution within the container at a sufficient temperature and for a sufficient time period to convert selenium and/or selenate within the sample to selenium selenite; and
a detector unit comprising:
a detector container to receive the conditioned sample from the conditioning unit; and
a voltammetry unit to perform cathodic stripping voltammetry utilizing the conditioned sample and in the detector container to determine a concentration of selenium within the conditioned sample.

10. The system of claim 9, wherein hydrochloric acid is provided in the conditioning solution at a concentration from about 4M to about 12M.

11. The system of claim 9, wherein nitric acid is provided in the conditioning solution at a concentration from about 5M to about 15M.

12. The system of claim 9, wherein the detector unit further comprises a source of a rhodium solution that adds rhodium to the conditioned sample within the detector container.

13. The system of claim 12, wherein the source of the rhodium solution provides rhodium in the conditioned sample in an amount from about 2 ppm to about 5 ppm.

14. The system of claim 9, further comprising a controller coupled with each of the conditioning unit and detector unit to facilitate selective and automated control of addition and removal of liquids into and from the container of the conditioning unit, heating of liquids within the heating unit, addition and removal of liquids into and from the detector container, and operation of the voltammetry unit to perform cathodic stripping voltammetry.

15. A fossil fuel power plant system comprising:
a fossil fuel power plant that burns a fossil fuel to generate electrical energy and outputs a flue gas;
a scrubbing system that removes one or more sulfur oxides from the flue gas output by the fossil fuel power plant and outputs a sulfur purified gas and a waste water stream;
a waste water treatment system that receives the waste water stream from the scrubbing system and removes one or more contaminants from the waste water stream, the one or more contaminants comprising one or more species of selenium; and
the continuous sampling and detection system of claim 9, wherein the aqueous sample is obtained as a portion of the waste water stream obtained from one or more locations within the waste water treatment system.

16. The fossil fuel power plant system of claim 15, wherein the scrubbing system comprises a wet flue gas desulfurization (FGD) system.
